(19) United States
(12) Patent Application Publication
(10) Pub. No.: US 2025/0170914 A1
(43) Pub. Date: May 29, 2025

(54) SYSTEM AND METHOD OF CHARGING AN ELECTRIC VEHICLE IN A PARKING LOT

(71) Applicant: Virind Gujral, Chester Springs, PA (US)

(72) Inventor: Virind Gujral, Chester Springs, PA (US)

(21) Appl. No.: 18/960,734

(22) Filed: Nov. 26, 2024

Related U.S. Application Data
(60) Provisional application No. 63/603,202, filed on Nov. 28, 2023.

(51) Int. Cl. B60L 53/37; B60L 53/16; B60L 53/30; B60L 53/53; B60L 53/65; B60L 53/66

(52) U.S. Cl. CPC B60L 53/37; B60L 53/16; B60L 53/305; B60L 53/53; B60L 53/65; B60L 53/66; B60L 2240/72

(57) ABSTRACT

The present disclosure describes a system and method of charging a vehicle in a parking lot. The system is communicatively coupled to one or more robots, one or more user devices, and one or more portable charging apparatus, via a network. The one or more robots travel autonomously and connect to one or more portable charging apparatus upon receiving a vehicle charging request. The one or more robots further navigate the one or more portable charging apparatus to vehicle's parking location. Each robot is capable of engaging with the portable charging apparatus via a towing mechanism present in rear portion of the robot. The towing mechanism actuates upon receiving the data from the plurality of sensors and upon reaching the robot within a predefined range of the portable charging apparatus, enabling precise alignment and connection between the robot and the portable charging apparatus via linear variable differential transformer (LVDT).

### CROSS-REFERENCE TO RELATED APPLICATIONS AND PRIORITY

This application claims benefit of priority from U.S. provisional patent application No. 63/603,202, filed Nov. 28, 2023, which is hereby incorporated by reference in its entirety.

### TECHNICAL FIELD

The present disclosure relates generally to the field of vehicle charging systems, and more specifically relates to a system and method of charging an electric vehicle in a parking lot.

### BACKGROUND

Background description includes information that may be useful in understanding the present disclosure. It is not an admission that any of the information provided herein is prior art or relevant to the presently claimed invention, or that any publication specifically or implicitly referenced is prior art.

In today's world, there is an increasing trend among the consumers and businesses of shifting from internal combustion engine vehicles to electric vehicles. Hence, deployment of charging infrastructure in order to support the electric vehicle drivers is a major challenge. Today, even with enough charging points/stations, charging of the electric vehicles takes longer than refueling the internal combustion engine vehicles. Electric vehicles, such as buses, cars, trucks, etc. are charged only at a limited number of charging stations where the charging infrastructure is present. In the case of a fleet of electric vehicles, multiple electric vehicles need to be recharged at the same time (e.g., when they are parked overnight at a depot, when multiple vehicles pull into a charging station, etc.). There is a need of new kind of charging infrastructure that can reduce the operating costs and other costs associated with charging a large fleet of the electric vehicles. Embodiments of the current disclosure may result in a decrease in charging related costs for electric vehicles. The scope of the present disclosure, however, is defined by the attached claims, and not by the ability to solve any specific problem.

### SUMMARY

Before the present systems, methods and apparatuses along with components related thereto are described, it is to be understood that this disclosure is not limited to the particular methods, apparatuses, systems and their arrangement as described, as there 1 can be multiple possible embodiments which are not expressly illustrated in the present disclosure but may still be practicable within the scope of the invention. It is also to be understood that the terminology used in the description is for the purpose of describing the particular versions or embodiments only, and is not intended to limit the scope of the present application. This summary is not intended to identify essential features of the subject matter nor it is intended for use in detecting or limiting the scope of the subject matter.

In one embodiment, a system of charging an electric vehicle in a parking lot is described. The system may be communicatively coupled to one or more robots, one or more user devices, and one or more portable charging apparatus, via a network. The one or more robots may be configured to travel autonomously and connect to one or more portable charging apparatus upon receiving a vehicle charging request from the user device. The one or more robots may navigate the one or more portable charging apparatus to vehicle parking location. Each robot may include a body, one or more robotic arms, two or more cameras, plurality of sensors, plurality of wheels, one or more battery units, and a towing mechanism. The body of each robot houses a drive unit, and enables mounting of the one or more robotic arms, the two or more cameras, the plurality of sensors, and the towing mechanism. The towing mechanism may be mounted at rear end of the body, and is capable of engaging with the portable charging apparatus. The towing mechanism of the robot may include an inverted U-shaped clamping device for attaching the robot to the one or more portable charging apparatus. The towing mechanism may be actuated upon receiving the data from the plurality of sensors and upon reaching of the robot within a predefined range of the portable charging apparatus. The towing mechanism of the robot may enable precise alignment and connection between the robot and the portable charging apparatus via linear variable differential transformer (LVDT). Each portable charging apparatus may include a battery platform, casing, and a battery mounting clamp. The battery platform may comprise a handle for engaging with the robot, and a slit mechanism which enables mounting and desired lateral movements of plurality of batteries over the battery platform. The plurality of batteries are locked and held securely in a fixed position via the battery mounting clamp while moving the portable charging apparatus along with the robot, and during charging of the vehicle.

In another embodiment, a method of charging an electric vehicle in the parking lot is described. The method may comprise a step of receiving, via the controller, a request for charging the vehicle from a user. The method may comprise a step of displacing, via the controller, the robot from present location towards one of the portable charging apparatus present at base station, wherein the one of the portable charging apparatus is selected by the robot based on either distance between robot and the portable charging apparatus, or amount of battery charge available in the portable charging apparatus, or distance between the portable charging apparatus and the vehicle, category of the vehicle, or any combination thereof. The method may comprise a step of connecting, via the controller, one of the portable charging apparatus to the robot by actuating a towing mechanism of the robot, wherein the towing mechanism actuates upon receiving the information from plurality of sensors of the robot and upon reaching of the robot within a predefined range of the portable charging apparatus. The method may comprise a step of transferring, via the controller, the robot and the engaged portable charging apparatus from the base station to the electric vehicle, by optimizing the route using real-time mapping data and one or more path planning algorithms. The method may comprise a step of actuating, via the controller, one or more robotic arms for placing the plug of the portable charging apparatus over charging port of the vehicle, upon reaching the vehicle's parking location. The method may comprise a step of communicating, via the controller, charging information with the system during the charging process at predefined intervals or instances of the vehicle charging. The method may comprise a step of actuating, via the controller, one or more robotic arms for placing the plug back to the portable charging apparatus from the charging port of the vehicle, upon completing the requested charging. The method may comprise a step of returning, via the controller, the portable charging apparatus to the base station, by connecting the robot and the portable charging apparatus through the towing mechanism of the robot.

In yet another embodiment, a non-transitory computer readable medium storing a program for enabling charging of an electric vehicle in the parking lot is described. The program may comprise a program code for receiving, via the controller, a request for charging the vehicle from a user. The program may comprise a program code for displacing the robot from present location towards one of the portable charging apparatus present at base station, wherein the one of the portable charging apparatus is selected by the robot based on one or more parameters, wherein the one or more parameters such as distance between robot and the portable charging apparatus, amount of battery charge available in the portable charging apparatus, distance between the portable charging apparatus and the vehicle, category of the vehicle, or any combination thereof. The program may comprise a program code for connecting the one of the portable charging apparatus to the robot by actuating a towing mechanism of the robot, wherein the towing mechanism is actuated based on the receiving the information from plurality of sensors of the robot and upon reaching of the robot within a predefined range of the portable charging apparatus. The program may comprise a program code for transferring the robot and the engaged portable charging apparatus to the electric vehicle, by optimizing the route using real-time mapping data and one or more path planning algorithms. The program may comprise a program code for actuating one or more robotic arms for placing the plug of the portable charging apparatus over charging port of the vehicle, upon reaching the vehicle's parking location. The program may comprise a program code for communicating the charging information with the system during the charging process at predefined intervals or instances of the vehicle charging. The program may comprise a program code for actuating one or more robotic arms for placing the plug back to the portable charging apparatus from the charging port of the vehicle, upon completing the requested charging. The program may comprise a program code for returning the portable charging apparatus to the base station, by connecting the robot and the portable charging apparatus through the towing mechanism of the robot.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation 100 of system 101 of charging an electric vehicle in a parking lot, in accordance with the present disclosure;

FIG. 2A illustrates a schematic plan 200 of the parking lot displaying a route of robot and portable charging apparatus, traveling towards the electric vehicle's parking location, in accordance with present disclosure;

FIG. 2B illustrates the charging of electric vehicle in the parking lot, in accordance with present disclosure;

FIG. 3 illustrates the system 101 of charging the electric vehicle, in accordance with present disclosure;

FIG. 4 illustrates the robot 104, in accordance to the present disclosure;

FIG. 5A illustrates the portable charging apparatus 105, in accordance to the present disclosure;

FIG. 5B illustrates the battery platform 501 of the portable charging apparatus 105, in accordance to the present disclosure;

FIG. 6A illustrates a tire cap opener device 610, in accordance to the present disclosure;

FIG. 6B illustrates a tire inflator device 620, in accordance to the present disclosure; and

FIG. 7 illustrates a method 700 of charging the electric vehicle in the parking lot, in accordance to the present disclosure.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

In the following description, numerous specific details are set forth in order to provide a thorough understanding of embodiments of the present disclosure. It will be apparent to one skilled in the art that embodiments of the present disclosure may be practiced without some of these specific details.

Embodiments of the present disclosure include various steps, which will be described below. The steps may be performed by hardware components or may be embodied in machine-executable instructions, which may be used to cause a general-purpose or special-purpose processor programmed with the instructions to perform the steps.

Alternatively, steps may be performed by a combination of hardware, software, firmware and/or by human operators.

If the specification states a component or feature “may”, “can”, “could”, or “might” be included or have a characteristic, that particular component or feature is not required to be included or have the characteristic.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Also, as used in the description herein, the meaning of “in” includes “in” and “on” unless the context clearly dictates otherwise.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the invention.

The present disclosure describes a system and method for charging electric vehicles. The present disclosure solves the problems of charging the electric vehicles in all weather conditions such as high winds, low and high temperatures, light and heavy snow, etc. While principles of the present disclosure are described with reference to specific types of electric vehicles, it should be understood that the disclosed charging systems and methods may be used in any electric vehicle application. The present disclosure is also applicable for charging of hybrid vehicles.

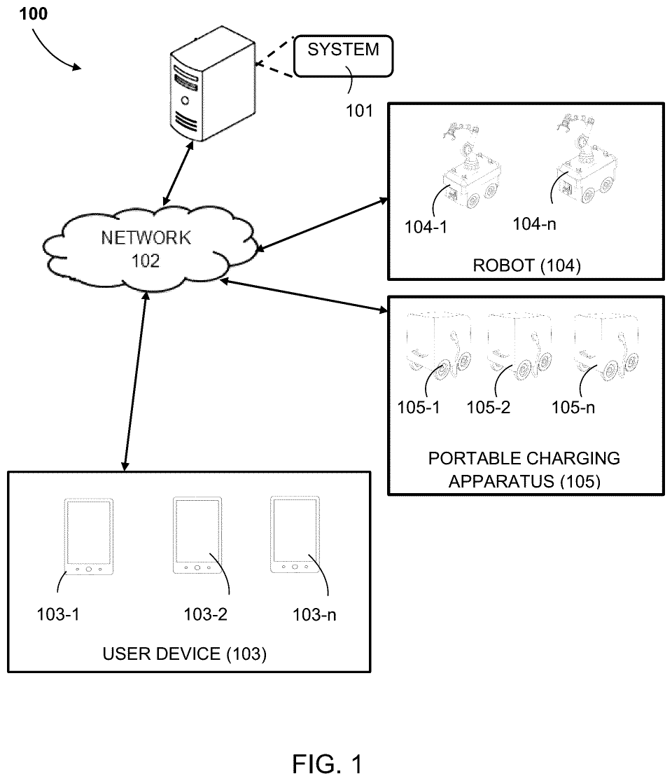

Referring to the FIG. 1, the system 101 may be communicatively coupled with one or more robots 104, one or more user devices 103, and one or more portable charging apparatus 105, via a network 102. The system 101 may enable charging of one or more electric vehicles via the one or more robots 104 in external parking lots as well as inside enclosed areas. The system 101 may receive vehicle charging requests from one or more user devices (103-1,103-2 . . . 103-n). (Hereinafter the term “one or more robots” is referred as “robot” and can be used interchangeably). In an embodiment, one user device (say 103) may be associated with a vehicle. The user device 103 may be either a smartphone or an on-board computer present inside the vehicle. The one or more electric vehicles may include, but not limited to, cars, light trucks, medium and heavy-duty trucks, buses, and the like. The system 101 may be capable of providing AC charging, DC to DC charging, and DC to Wireless charging, to the electric vehicles. The system 101 may be configured to enable the robot 104 for selecting a one of the connectors/plugs from an available set of multiple connectors in order to charge different electric vehicles having different charging ports (such as Combined Charging System). In an embodiment, the on-board computer present in the electric vehicle or a mobile application present over the user device 103 may be connected to the system 101 via a network 102, for placing a request for charging of the electric vehicle by the user/driver.

The system 101 may deploy one or more robots 104, and one or more portable charging apparatus 105 in order to facilitate charging of the electric vehicles autonomously. (Hereinafter the terms “one or more vehicles” and “one or more portable charging apparatus” are also referred as “vehicle” and “portable charging apparatus” respectively, and may be used interchangeably). In an embodiment, the robot 104 may perform activities, but not limiting to, engage/disengage the portable charging apparatus 105, opening/closing the charging socket flap of the vehicle, connect the charging plug to charging port of the electric vehicle and remove the plug from charging port of the electric vehicle. The robot 104 may work autonomously wherein the entire charging process for the electric vehicle is executed without any human intervention.

In one embodiment, the charging port of the vehicle may be a standardized charge port (e.g., SAE J1772 charge port) that is configured to receive a corresponding standardized plug/connector (e.g., SAE J1772 connector). As would be recognized by people of ordinary skill in the art, SAE J1772 charge port and SAE J1772 connector is a standardized pair of electrical connectors for electric vehicles in the United States. However, the standardized charge port and connector may not be requirements in all. As would be recognized by a person skilled in the art, any suitable now-known or future-developed connector and plug (standardized or non-standard) may be used as connector/plug and charge port. In some embodiments, different types/configurations of connectors/plug charge the electric vehicles having corresponding types of charge ports.

In an embodiment, the robot 104 enables travel of the charging infrastructure (portable charging apparatus 105) towards the vehicle parking location and is designed for charging the electric vehicles considering different parking facilities viz., multi-storey parking, open parking lot and underground/basement parking lot, etc. It can be said that, the robot 104 is accessible through the system 101 that allows the users/drivers of the electric vehicle to leave their vehicles (such as trucks, cars, buses, etc.) in the parking lot so that the robot 104 automatically finds the vehicle, and provides desired charging to them.

Furthermore, in terms of applicability, the system 101 may be used to charge a fleet of electric vehicles, such as, for example, electric cars, electric trucks, electric buses, etc. Many of the vehicles may be parked at a parking location/lot for a long period of time. The parking time for each vehicle may vary due to numerous personal reasons such as office work, shopping, meeting, working shift, or sometimes overnight. For example, electric delivery trucks may be parked in the parking lot when they are not used for transporting of goods.

In one embodiment, the one or more robots 104 may be configured to travel autonomously and connect to one or more portable charging apparatus 105 upon receiving a vehicle charging request. The vehicle charging may be requested by a user via the user device 103. Upon receiving the vehicle charging request, the system 101 may transmit instructions to the robot 104 to connect and navigate the portable charging apparatus 105 towards respective vehicle's parking location.

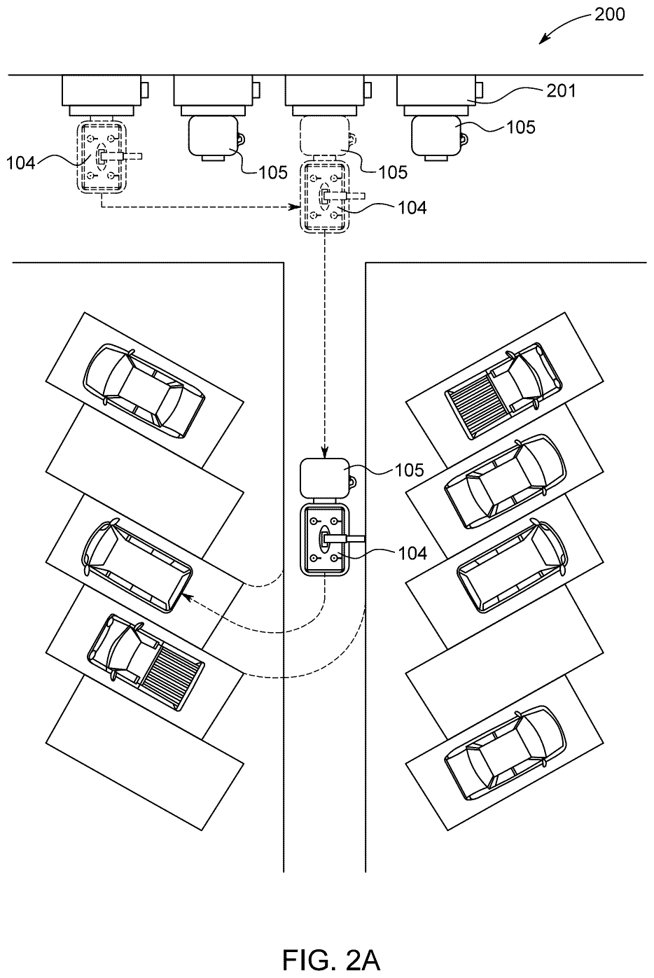

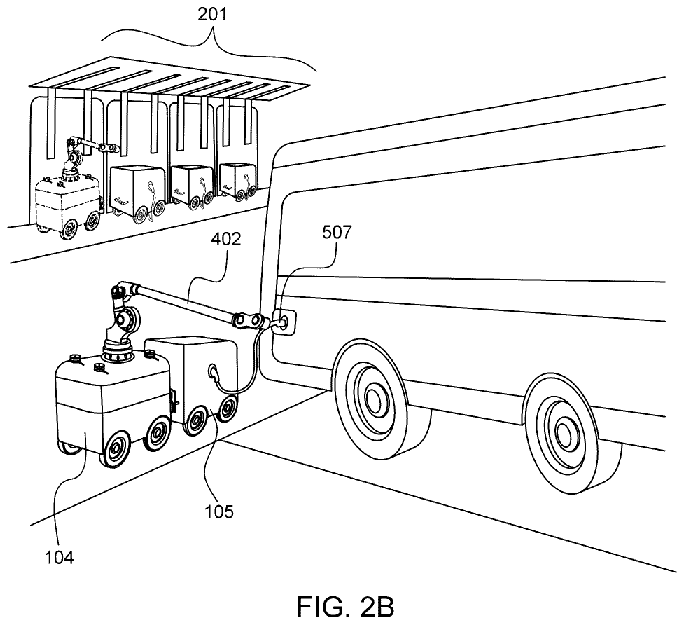

Referring to the FIGS. 2a and 2b, the robot 104 can drive autonomously, and may further comprise, but not limiting to, cameras, scanners, sensors or a combination thereof. Such components not only enable the robot 104 to perform the electric vehicle charging process completely autonomously but also to move around in the parking lot, recognizing the vehicles and its category, possible obstacles and to take desired actions accordingly.

The robot 104 may be connected to the system 101 via the network. The network 102 may be wired or a wireless network. In an embodiment, each robot 104 may house one or more battery units (not shown), enabling the robot 104 to execute the instructions such as, but not limited to, traveling from/towards portable charging apparatus, engage/disengage the portable charging apparatus, placing plug to the charging port in the vehicle, opening/closing the charging port cover/lid of the vehicle, traveling from/towards the electric vehicles within the parking lot, and the like. Each battery unit of the robot 104 may be a smart battery, capable of transmitting information to the robot 104 over the network 102. The robot 104 is capable of receiving additional information on the robot's own one or more battery units, and the one or more batteries of the portable charging apparatus 105. Furthermore, the robot 104 is capable enough to locate the electric vehicle, and connect the plug from the portable charging apparatus 105 to charging port of the vehicle to replenish the battery of the vehicle. After the charging of the electric vehicle is completed, the robot 104 may engage the portable charging apparatus again, and travel either to the next vehicle for charging the vehicle or return to the charging station for recharging the discharged battery of the portable charging apparatus 105 or its own battery. Moreover, the robot 104 may also be docked to the base station 201 for charging the one or more battery units of the robot during the idle time, and getting ready for the next task/vehicle charging.

In one embodiment, the robot 104 may be configured to locate a charging port of the vehicle based on the charging information provided by the user in the system 101. The charging information may be quantity of charging required, vehicle type, vehicle model/variant, vehicle name, vehicle year, or any combination thereof. In another embodiment, a custom machine learning (ML) model may be installed in the system, enabling the robot for detecting the vehicle and vehicle charging port type. The ML model may further enhance the accuracy of the vehicle charging process.

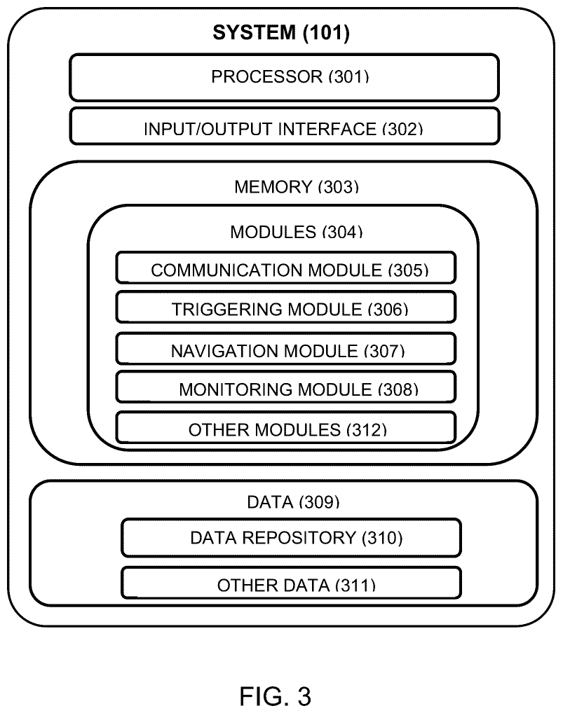

Referring to the FIG. 3, the system 101 may comprise a system processor 301, an input/output interface 302 (referred to as I/O interface 302 hereinafter) and a system memory 303. The processor 301 may be implemented as one or more microprocessors, microcomputers, microcontrollers, digital signal processors, central processing units, state machines, logic circuitries, and/or any devices that manipulate signals based on operational instructions. Among other capabilities, the processor 301 is configured to fetch and execute computer-readable instructions stored in the memory 303.

The I/O interface 302 may include a variety of software and hardware interfaces, for example, a web interface, a graphical user interface, and the like. The I/O interface 302 may allow the system 101 to interact with a user directly or through the user devices 103. Further, the I/O interface 302 may enable the system 101 to communicate with other computing devices, such as web servers and external data servers (not shown). The I/O interface 302 can facilitate multiple communications within a wide variety of networks and protocol types, including wired networks, for example, LAN, cable, etc., and wireless networks, such as WLAN, cellular, or satellite. The I/O interface 302 may include one or more ports for connecting number of devices to one another or to another server.

The system memory 303 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The system memory 303 may include modules and data 310.

The modules 304 include routines, programs, objects, components, data structures, etc., which perform particular tasks or implement particular abstract data types. In one implementation, the modules 304 may include a communication module 305, a triggering module 306, a navigation module 307, a monitoring module 308, and other modules 312. A communication channel may be established among the user device 103 and the system 101 that includes, but not limited to, receiving, transmitting, executing and monitoring.

The communication module 305 may be configured to receive the vehicle charging request via the user device 103. The communication module 305 may validate the information relating to the vehicle charging request. The information may be, but not limited to, quantity of charging required, vehicle type, vehicle model/variant, vehicle name, vehicle year, or any combination thereof. Furthermore, the communication module 305 may be configured to transmit a notification to the user device upon completion of the vehicle charging request.

The triggering module 306 may be configured to initiate the vehicle charging process. The triggering module 306 may activate one of the robots 104 for traveling towards the one or more portable charging apparatus 105, engaging the one or more portable charging apparatus 105 from the base station 201, and further traveling towards the vehicle's parking location.

The navigation module 307 may be configured to navigate the robot 104 autonomously within the parking lot. The navigation module 307 may enable optimization of the route of the robot 104, for traveling towards the one or more portable charging apparatus 105, and towards the vehicle for charging. The route may be optimized via custom navigation system, one or more path planning algorithms, and avoiding obstacles in the real-time mapping data.

The monitoring module 308 may be configured to monitor the activities such as, but not limited to, all tasks of the robot 104, status of the batteries present in the portable charging apparatus 105, robot's one or more battery units' status, and outstanding/upcoming charging requests of the system 101. The module 308 may be further configured to update the information in the system 101 on real-time basis or at predefined intervals.

The data 309, amongst other things, serves as a repository for storing data processed, received, and generated by one or more of the modules 304. The data 309 may also include a data repository 310 and other data 311. The user profiles and the vehicle information may be stored in the data repository 310. The other data 311 may include data generated as a result of the execution of one or more modules in the other module 312.

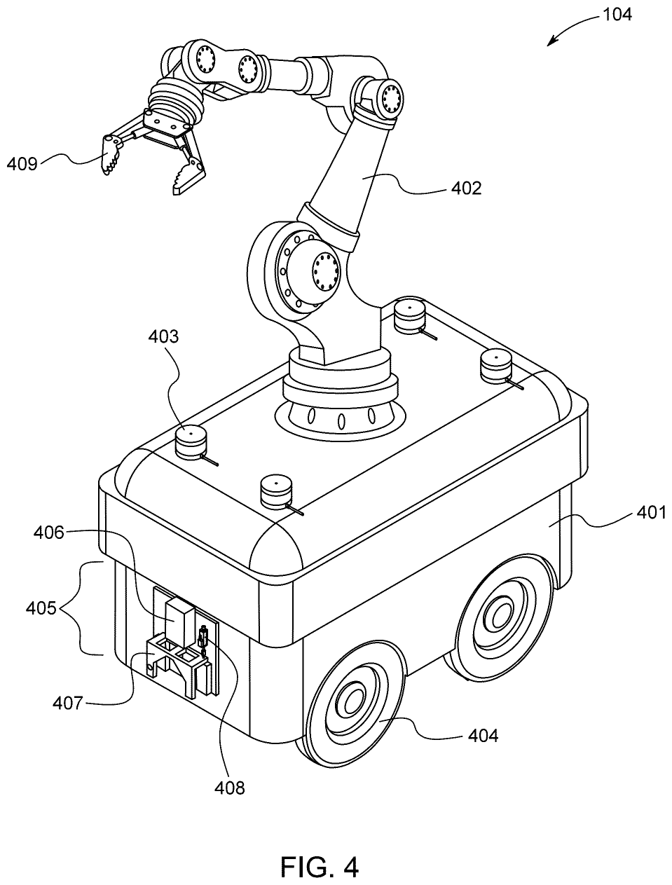

Referring to FIG. 4, the robot may include a body 401, one or more robotic arms 402, two or more cameras, plurality of sensors 403, plurality of wheels 404, a controller, a memory, one or more battery units, and a towing mechanism 405. The body of the robot may house a drive unit, which is either a rear-wheel drive unit, or a front-wheel drive unit or an all-wheel drive unit. The body 401 may further enable mounting of the one or more robotic arms 402, the two or more cameras, the plurality of sensors 404, and the towing mechanism 405. Each robotic arm 402 may include a plurality of movable joints that are capable of moving an end effector 409 of the robot 104 in at least 5 degrees of freedom. In an embodiment, each robotic arm 402 may be UR3e robotic arm type. The robotic arm 402 may enable high precision in terms of interaction with the charging related tasks of the robot 104. The robotic arm 402 may be equipped with a second depth camera for detecting the charging port of the electric vehicle. The one or more battery units of the robot 104 may be used for performing all the tasks by the robot 104, such as traveling of robot 104 from one place to another, actuating one or more robotic arms 402, providing power supply to the plurality of sensors 403, cameras, processor, etc. of the robot 104.

In one embodiment, the plurality of sensors 403 may be selected from, but not limited to, proximity sensors, light sensors, Light Detection and Ranging (LiDAR) sensors, thermal sensors, acceleration sensors, and any combination thereof. The plurality of sensors 403 may be either mounted on front side of the body 401, or rear side of the body 401, or both. The plurality of sensors 403 may provide data/information to a custom navigation system and one or more path planning algorithms, for optimal route/path planning of the robot 104 for traveling towards the portable charging apparatus 105 present at the base station 201, and/or vehicle's parking location, and avoiding obstacles during the traveling.

In one embodiment, the two or more cameras may be depth cameras. The LiDAR sensors 403 and first depth camera may be mounted on top and front side of the body 401 respectively, enabling real-time obstacle detection and environmental route mapping for the robot 104. Moreover, the second depth camera may be present over the one or more robotic arms 402. The depth cameras of the robot 104 may detect the vehicle, locate the vehicle's charging port, and ensure precise connection of the charging plug of the portable charging apparatus 105 with the charging port of vehicle. It can be said that, the route of the robot 104 is optimized via the first depth camera using the real-time mapping data, and one or more path planning algorithms.

In one embodiment, the one or more robotic arms 402 play a key role in the vehicle charging process. Each robotic arm 402 may be equipped with the second depth camera for enabling detection of the vehicle charging port. Furthermore, the robotic arm 402 may manipulate and insert the charging plug (say, Combined Charging System Type 1) from the portable charging apparatus 105 over the vehicle's charging port along with high precision and alignment. Once the charging plug of the portable charging apparatus 105 is connected to the charging port of the vehicle, the charging of the vehicle may be initiated.

In one embodiment, the towing mechanism 405 may be mounted at rear portion/end of the body 401, and is capable of engaging with the portable charging apparatus 105. The towing mechanism 405 of the robot 104 may include a servo motor 406 and an inverted U-shaped clamp 407. The clamp 407 may be connected with the servo motor 406 via mechanical means. The mechanical means may be lead screws arrangement, and the like. The clamp 407 plays a vital role in engaging the robot 104 and the portable charging apparatus 105. The clamp 407 may be triggered via the servo motor 406 and the lead screw arrangement to displace in vertical manner, for engaging/disengaging the portable charging apparatus 105 to the robot 104. The towing mechanism 405 may be actuated upon receiving the data from the plurality of sensors 403, and upon reaching the robot 104 within a predefined range of the portable charging apparatus 105. The towing mechanism 405 of the robot 104 may enable precise alignment and connection between the robot 104 and the portable charging apparatus 105 via linear variable differential transformer (LVDT) 408.

In one embodiment, the robot 104 may further comprise a controller, and a memory. The robot may be communicatively coupled with the system 101 via the network 102. The controller may be configured to receive information and execute a set of programmed instructions stored in the memory. The controller may optimize, via the two or more cameras, the route for reaching from base station 201 to the vehicle's parking location. The route of the robot 104 may be optimized using the real-time mapping data, and one or more path planning algorithms. The controller may identify, via the one or more cameras, the vehicle on basis of reading license plate, color, vehicle type, or any combination thereof. Upon reaching the vehicle parking location, the controller may locate, via the one or more cameras, charging port of the vehicle. The controller may further obtain, via one or more robotic arms 402, an access to the charging port of the vehicle. The controller may align, via one or more robotic arms 402, the movable joints to end effector 409 of the robot 104 by holding the plug of the portable charging apparatus 105, with respect to the charging port of the vehicle. The controller may electrically couple, via one or more robotic arms 402, the plug 507 of the portable charging apparatus to the charging port of the vehicle. The controller may further monitor the charging of the vehicle such as, but not limited to, amount of charging completed, amount of charging remaining in the batteries of the portable charging apparatus 105, amount of charging remaining in the batteries of the robot 104, and the like. The controller may receive a notification from one of the batteries present in the portable charging apparatus 105 upon completing desired charging or upon full charging of the vehicle.

Moreover, the controller may be configured to locate the charging port of the vehicle based on the vehicle charging information provided by the user device 103 in the system 101. The information provided by the user device 103 may be quantity of charging required, vehicle type/category, vehicle model/variant, vehicle name, vehicle year, or any combination thereof.

Furthermore, the controller, upon complete charging or desired charging of the vehicle, may be configured for removing the plug 507 of the portable charging apparatus 105 from the charging port of the vehicle, placing the plug 507 back to the cavity present over the casing 502 of the portable charging apparatus 105, further connecting the robot 104 and the portable charging apparatus 105 autonomously via the towing mechanism 405, and transporting the portable charging apparatus 105 to the base station 201 or towards another vehicle for charging. In an embodiment, the robot 104 may further return to the base station 201 to replenish its own battery or may perform a new task as allocated via the system 101. The new task may be allocated on the basis of battery charge available with the robot 101.

Thus, it can be said that the robot 104 facilitates towing of the portable charging apparatus 105 from the base station 201 to the electric vehicle and vice-versa. The robot 104 brings the portable charging apparatus 105 in the form of a mobile energy storage device towards the electric vehicle and connects the batteries of the portable charging apparatus 105 via the plug to the electric vehicle for charging.

In an embodiment, the robot 104 travels to the vehicle's parking location that requires charging, and communicates with the vehicle after receiving the instructions from the system 101. The entire process of charging the electric vehicle occurs without any human intervention i.e. opening the charging socket flap, connecting the charging plug 507 and decoupling the plug 507 from the vehicle.

In an embodiment, the controller may be embodied as one or multiple digital computers or data processing devices, having one or more microcontrollers or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, and/or signal conditioning and buffering electronics. The controller may be embodied as distinct software modules within a single computing device, or may be embodied as physically separate hardware modules.

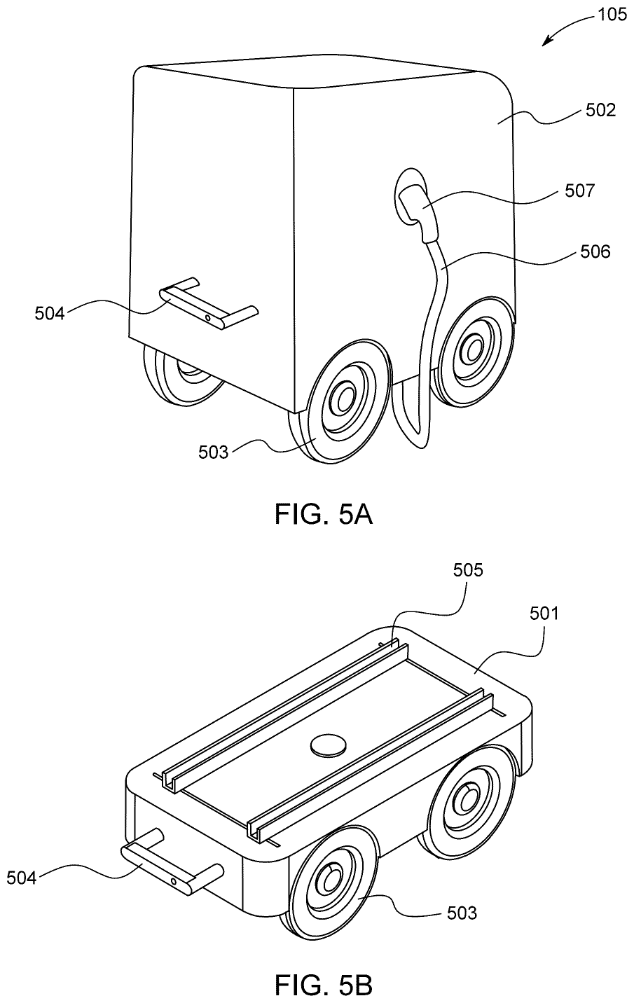

Referring to FIGS. 5a and 5b, the portable charging apparatus 105 may include a battery platform 501, a casing 502, plurality of wheels 503 and a battery mounting clamp. The battery platform 501 may comprise a handle 504, visible on the exterior side of the portable charging apparatus 105. The towing mechanism 405 of the robot 104 may engage with the handle of the portable charging apparatus 105. The casing 502 of the portable charging apparatus 105 may cover/house the battery platform 501, and the battery mounting clamp. The battery platform 501 may further comprise a slit mechanism, wherein the slit mechanism includes a pair of tracks 505, which enables mounting and desired lateral movements of plurality of batteries over the battery platform 501. Each track 505 may be of a U-shaped profile, and consists of two or more rails in a parallel arrangement. The plurality of batteries are clamped/locked and held securely in a fixed position via the battery mounting clamp while traveling/moving of the portable charging apparatus 105 along with the robot 104, and during charging process of the vehicle. The portable charging apparatus 105 may further include a flexible electrical cable 506, which is coupled to the plug 507 from the one or more batteries present inside the casing 502 of the portable charging apparatus 105. The one or more batteries of the portable charging apparatus 105 may be smart batteries, capable of communicating and exchanging information with the robot 104 and the system 101, connected over the network 102. The plug 507 may be placed within a cavity present over the exterior side of the casing 502. The plug 507 may be capable of transferring the electric supply from/to the one or more batteries of the portable charging apparatus 105. The portable charging apparatus 105 provides current either in form of AC supply, or DC supply or both. In an embodiment, the portable charging apparatus 105 may comprise one or more charging plugs 507 in order to cater and connect to different charging ports present in different vehicles. In an embodiment, the robot 104 may identify the charging port of the vehicle and select relevant type of the charging plug 507 from the portable charging apparatus 105 for charging of the vehicle.

In another embodiment, the system 101 may transmit the instructions to the robot 104 for, but not limited to, inspecting the exterior of the electric vehicle, inspecting the vehicle tire parameters, such as tread depth, air pressure, filling of air in the tire, removing and placing tire cap present over valve stem. Furthermore, the tire tread depth may be measured and recorded via the one or more robotic arms 402 by using a digital tire depth gauge. The reading of the tread depth may be further transmitted to the user device 103 via the system 101.

Furthermore, the system 101 may transmit instructions to the robot 104 for checking air pressure in the one or more vehicle tires. The filling of air into the vehicle tire may be performed based on the tyre pressure monitoring system present at the vehicle tires. The robot 104 may comprise a tire cap opener device 610 and a tire inflator device 620, for screwing/unscrewing of valve cap of the vehicle tire, and inflating the air pressure in the vehicle tires respectively. The one or more cameras of the robot 104 may read the vehicle tire information present on the side face of the tire in order to fill optimum air pressure in the respective tire.

The working of the present disclosure is explained below with an example. A system user may place a request for charging of the electric vehicle over the system 101 via a vehicle on-board computer or via mobile application present in a user device 103 (such as smartphone and the like). The user may select one or more activities, but not limiting to, charging of the vehicle, and other additional services such as inspecting vehicle tire parameters, etc. The user's request can be validated and transmitted to the system 101 only after essential entries of the request have been entered correctly by the user. The essential entries may include amount of charging required, vehicle type, license plate number, desired time slot for charging, parking lot location, payment details, and the like. The system 101 further instructs a one of the robots 104 present at the requested parking location to perform the activities selected by the user in the charging request. The robot 104 may further plan a route to the vehicle's parking location, and tow along one of the portable charging apparatus 105 present at the base station 201, towards the vehicle for charging of the vehicle. The robot 104 may identify obstacles in the path and may change the path to avoid them accordingly based on the real-time mapping data, and one or more path planning algorithms. The robot 104 may further identify the electric vehicle at the location by either reading the license plate, checking vehicle type/model, GPS location or any combination thereof. In the next step, the robot 104 may plug position the charging plug 507 from the portable charging apparatus 105 to the charging port of the vehicle. The robot 104 may also either remove the plug 507 from the vehicle upon completion of desired charging, disengage the portable charging apparatus 105 and/or perform other activities. Meanwhile, the portable charging apparatus 105 is left near the vehicle for charging of the electric vehicle by the robot 104. When the charging of the vehicle is complete, the robot 104 may come back to the electric vehicle's location and decouple the plug 507 from the vehicle, and engage and tow along the portable charging apparatus 105 for charging other vehicles or may return back to the base station 201 based on the status of the batteries present inside the portable charging apparatus 105 and outstanding/upcoming charging tasks for the robot 104.

The portable charging apparatus 105 is disengaged from the robot 104 and stays at the vehicle's location during the whole charging process. The robot 104, in the meantime, may either cater charging services or other services to other electric vehicles present in the parking lot using other portable charging apparatus 105 available for use. Furthermore, the robot 104 may further transmit a notification to the system 101 for completion of the vehicle charging task assigned to the robot 104. Further, the request status is updated in the system database and may also transmit a notification to the user device 103.

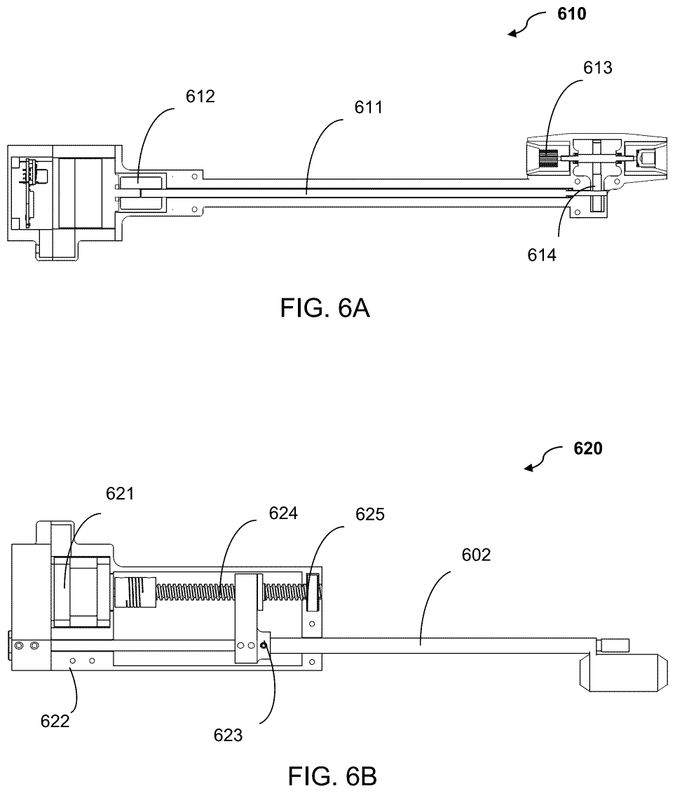

Referring to the FIG. 6A, the tire cap opener device 610 may be mounted over the one of the robotic arms 402. The tire cap opener device 610 may be configured to precisely remove and reattach the valve cap present over valve stem of the vehicle tire, by adjusting the robotic arms 402. (Hereinafter the term “valve cap’ may be referred as “cap’ and may be used interchangeably). The device 610 may be positioned precisely over the cap, and securely lock on the cap. The device 610 may unscrew the cap and retain the cap within the device 610. The device 610 may comprise of a rod 611, a stepper motor 612, a cap holder 613, and a transmission 614. The stepper motor 612 may be coupled with the transmission 614 via electro-mechanical means. The transmission 614, via one or more spur gears, may enable rotation of the cap holder 613, wherein the valve cap is unscrewed or screwed/fastened through the device 610. The transmission 614 may further enable rotation of the cap holder 613 in clockwise as well as anti-clockwise direction. The cap holder 613 may further enable a secure fit over the valve cap, for unscrewing and screwing of the caps from either side of the vehicle, regardless of the valve stem's position. After the valve cap is unscrewed/removed from the cap, the cap holder 613 may hold the cap into the cap holder 613, until the cap has to be placed back over the tire after the tire inflation process is completed.

Moreover, the cap holder 613 includes a tapered surface design along with special grooves, facilitating perfect alignment of the cap within the cap holder 613. The special grooves may further enable locking the cap inside the cap holder 613 for holding, and also ensures unscrewing and screwing of the cap over the vehicle tire without any failure.

Referring to the FIG. 6B, the tire inflator device 620 may be mounted over the one of the robotic arms 402. The tire inflator device 620 may be configured for inflating and/or deflating the vehicle tire to the optimal air pressure of the tire, by adjusting the robotic arms 402. The device 620 may comprise a stepper motor 621, a casing 622, a bearing housing 623, a locking apparatus 624 and an actuator 625. The device 622 may be securely attached to the vehicle tire upon engagement of the device 622 with the valve stem of the tire. The locking apparatus 624 enables locking/freezing of the device 620 with the tire, and initiate inflating/deflating of the air based on the desired pressure of the tire. The stepper motor 621 provides a precise control over the tire inflating rate, ensuring that the air is filled to the specified pressure. Once the target pressure is reached, the device 620 autonomously ceases the inflation process, and disengages from the valve stem, effectively unlocking itself from the valve stem.

In an embodiment, the device 620 may be connected to an air compressor via a flexible hose and wires. The locking apparatus 624 may include a lead screw and a bearing. The device 620 may enable the locking apparatus 624 to freeze the lead screw at a predefined position when the device 620 is engaged with the vehicle tire. Upon reaching the desired tire pressure, a signal may be received by the stepper motor 621 to release the lead screw by turning in opposite direction via the actuator 625, and disengage the device 622 from the vehicle tire.

In one embodiment, the robotic arm 402 is configured for locating a valve stem of vehicle tyre, engage the tire cap opener device 610 precisely over the cap, unscrewing the cap from the valve stem by actuating the tire cap opener device 610, and removing the tire cap opener device 610 after the cap is completely unscrewed from the tire, engaging the tire inflator device 620 to the valve stem of the vehicle tire, and inflating the vehicle tire via the tire inflator device 620 for obtaining the desired tire pressure, wherein the stepper motor 621 of the tire inflator device 620 enables control over the tire inflation rate, and ensuring filling of air upto predefined pressure. The robot 104 may be further configured for disengaging the tire inflator device 620 from the valve stem of the tire upon achieving predefined pressure in the tire, screwing/turning the cap over the valve stem by using the tire cap opener device 610 wherein the cap is already present within the tire cap opener device 610, and ensuring a secure fit of the cap over the valve stem of the tire.

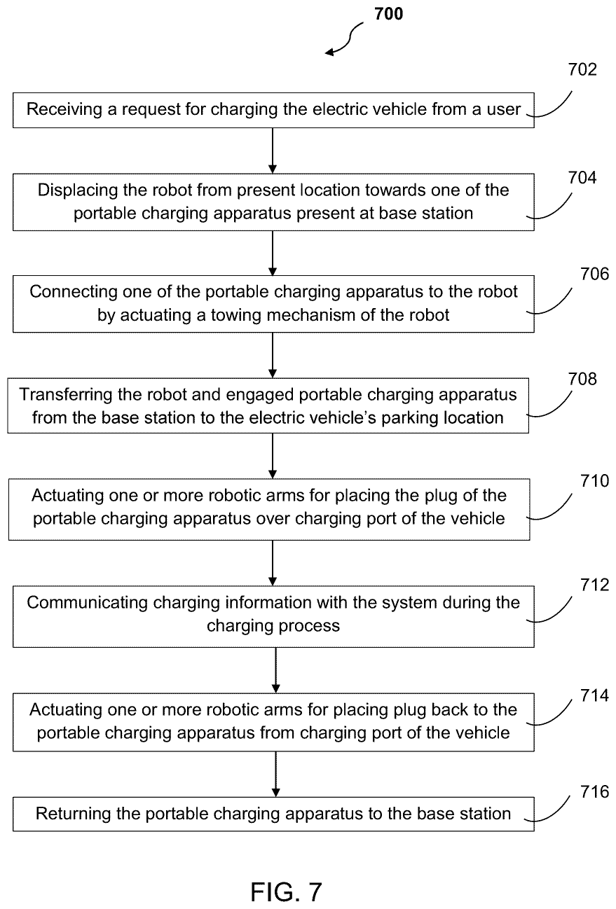

FIG. 7 illustrates a method 700 of charging the electric vehicle present in a parking lot, in accordance to an embodiment of the present disclosure. At step 702, the controller of the robot 104 receives a request for charging the vehicle from a user. The charging request may include the information, but not limited to, quantity of charging, vehicle type, vehicle model/variant, vehicle name, vehicle year, or any combination thereof. At step 704, the controller may trigger the robot 104 to displace from present location towards one of the portable charging apparatus present at base station 201. The one of the portable charging apparatus 105 may be selected by the robot 104 based on either, but not limited to, distance between robot and the portable charging apparatus 105, or amount of battery charge available in the portable charging apparatus 105, or distance between the portable charging apparatus 105 and the vehicle, quantity of charging required, category of the vehicle, or any combination thereof. At step 706, the controller may enable the robot to connect to one of the portable charging apparatus 105 by actuating the towing mechanism 405 present at the rear portion of the robot 104. The towing mechanism 405 actuates upon receiving the information from plurality of sensors 403 of the robot 104 and upon reaching of the robot 104 within a predefined range of the portable charging apparatus 105. At step 708, the controller may enable transfer of the robot 104 and the engaged portable charging apparatus 105 from the base station 201 to the electric vehicle, by optimizing the route using real-time mapping data and one or more path planning algorithms. In an embodiment, the route of the robot 104 may be further optimized via custom navigation system, one or more path planning algorithms, and avoiding obstacles in the real-time mapping data.

At step 710, the controller may actuate one or more robotic arms 402 for inserting/placing the plug 507 of the portable charging apparatus 105 over charging port of the vehicle, upon reaching the vehicle's parking location. At step 712, the controller may communicate and/or provide the charging information to the system 101 during the charging process at predefined intervals or instances of the vehicle charging. At step 714, the controller may further actuate one or more robotic arms 402 for placing the plug 507 back to the portable charging apparatus 105 from the charging port of the vehicle, upon completing the requested charging. At step 716, the controller may return the portable charging apparatus 105 to the base station 201 upon completion of desired charging of the vehicle, by connecting the robot 104 and the portable charging apparatus 105 through the towing mechanism 405. In another embodiment, the robot 104 may travel either towards other portable charging apparatus 105 or towards other vehicle present in the parking lot based on the instructions received from the system 101, by disengaging the presently engaged portable charging apparatus 105 during charging of the vehicle.

In another embodiment, a non-transitory computer readable medium storing a program for enabling charging of vehicle in the parking lot is described. The program may comprise a program code for receiving, via the controller, a request for charging the vehicle from a user. The program may comprise a program code for displacing the robot 104 from present location towards one of the portable charging apparatus 105 present at base station 201, wherein the one of the portable charging apparatus 105 is selected by the robot 104 based on one or more parameters, wherein the one or more parameters such as distance between robot and the portable charging apparatus 105, amount of battery charge available in the portable charging apparatus 105, distance between the portable charging apparatus 105 and the vehicle, category of the vehicle, or any combination thereof. The program may comprise a program code for connecting the one of the portable charging apparatus 105 to the robot 104 by actuating a towing mechanism 405 of the robot 104, wherein the towing mechanism 405 is actuated based on the receiving the information from plurality of sensors 403 of the robot 104 and upon reaching of the robot 104 within a predefined range of the portable charging apparatus 105. The program may comprise a program code for transferring the robot 104 and the engaged portable charging apparatus 105 to the electric vehicle, by optimizing the route using real-time mapping data and one or more path planning algorithms. The program may comprise a program code for actuating one or more robotic arms 402 for placing the plug 507 from the portable charging apparatus 105 over the charging port of the vehicle, upon reaching the vehicle's parking location. The program may comprise a program code for communicating charging information with the system 101 during the charging process at predefined intervals or instances of the vehicle charging. The program may comprise a program code for actuating one or more robotic arms 402 for placing the plug 507 back to the portable charging apparatus 105 from the charging port of the vehicle, upon completing the requested charging. The program may comprise a program code for returning the portable charging apparatus 105 to the base station 201 upon completion of desired charging of the vehicle, by connecting the robot 104 and the portable charging apparatus 105 through the towing mechanism 405 of the robot 104.

In an exemplary embodiment, the system 101 provides an improved electric vehicle charging infrastructure via machine learning, and artificial intelligence deep-learning, thereby providing and recommending suitable time slots for charging the vehicle by analysing customer patterns to provide optimized experience.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While principles of the present disclosure are described with reference to specific embodiments, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description. For example, while certain features have been described in connection with various embodiments, it is to be understood that any feature described in conjunction with any embodiment disclosed herein may be used with any other embodiment disclosed herein.

What is claimed is:

1. A system 101 of charging an electric vehicle in a parking lot, wherein the system 101 is communicatively coupled to one or more robots 104, one or more user devices 103, and one or more portable charging apparatus 105, via a network 102;
wherein the one or more robots 104 is configured to travel autonomously and connect to one or more portable charging apparatus 105 upon receiving a vehicle charging request from the user device 103, and navigate the one or more portable charging apparatus 105 to vehicle parking location, wherein each robot 104 includes a body 401, one or more robotic arms 402, one or more cameras, plurality of sensors 403, plurality of wheels 404, one or more battery units, and a towing mechanism 405, wherein the body 401 of each robot 104 houses a drive unit, and enables mounting of the one or more robotic arms 402, the two or more cameras, the plurality of sensors 403, and the towing mechanism 405;
wherein the towing mechanism 405 is mounted at rear end of the body 401, and is capable of engaging with the portable charging apparatus 105, wherein the towing mechanism 405 of the robot 104 includes a servo motor 406, and an inverted U-shaped clamp 407 for attaching the robot to the one or more portable charging apparatus 105, wherein the towing mechanism 405 actuates upon receiving the data from the plurality of sensors 403 and upon reaching of the robot 104 within a predefined range of the portable charging apparatus 105, wherein the towing mechanism 405 of the robot 104 enables precise alignment and connection between the robot 104 and the portable charging apparatus 105 via a linear variable differential transformer 408;
wherein each portable charging apparatus 105 includes a battery platform 501, a casing 502, and a battery mounting clamp, wherein the battery platform 501 comprises a handle 504 for engaging with the robot 104, and a slit mechanism that includes a pair of tracks 505 for mounting and desired lateral movements of plurality of batteries over the battery platform 501, wherein the plurality of batteries are locked and held securely in a fixed position via the battery mounting clamp while moving the portable charging apparatus 105 along with the robot 104, and during charging of the vehicle.

2. The system of claim 1, wherein each robot 104 comprises a controller and a memory, wherein the controller is configured to receive information and execute a set of programmed instructions stored in the memory, wherein the controller is configured to:
optimize, via the one or more cameras, the route for reaching from the base station 201 to the vehicle's parking location;
identify, via the one or more cameras, the vehicle on basis of either license plate, color, vehicle type, or a combination thereof;
locate, via the one or more cameras, charging port of the vehicle;
obtain, via one or more robotic arms 402, access to the charging port of the vehicle;
align, via one or more robotic arms 402, the movable joints to end effector 409 with respect to the charging port of the vehicle; and
electrically couple, via one or more robotic arms 402, the plug 507 of the portable charging apparatus 105 to the charging port of the vehicle.

3. The system of claim 2, wherein the robot 104 enables the clamp 407 to displace in vertical manner, for engaging the robot 104 with the portable charging apparatus 105.

4. The system of claim 1, wherein each robotic arm 402 includes a plurality of movable joints capable of moving end effector 409 of the robot 104 in at least 5 degrees of freedom.

5. The system of claim 2, wherein the controller of the robot 104 optimizes route for reaching from the portable charging apparatus's location to the vehicle via real-time mapping data, and one or more path planning algorithms.

6. The system of claim 1, wherein the plurality of sensors 403 are selected from proximity sensor, light sensor, Light Detection and Ranging (LiDAR) sensor, an acceleration sensor, and thermal sensor.

7. The system of claim 1, wherein the charging information provided by the user in the system 101 comprises either quantity of charging required, vehicle type, vehicle model/variant, vehicle name, vehicle year, or combination thereof.

8. The system of claim 1, wherein the portable charging apparatus 105 includes a flexible electrical cable 506 further coupled to a plug 507 for providing the electric current supply from the one or more batteries of the portable charging apparatus 105 to the electric vehicle.

9. The system of claim 8, wherein the portable charging apparatus 105 provides electric current supply either in form of AC supply, or DC supply or both.

10. The vehicle charging station of claim 2, wherein the controller is configured to obtain access to the charging port by adjusting the one or more of the movable joints, such that the end effector 409 of the robot 104 opens a door that selectively connects the plug 507 of the portable charging apparatus 107 to the charging port of the vehicle.

11. The system of claim 1, wherein the controller monitors the charging of the vehicle, and further receives a notification from one of the batteries present in the portable charging apparatus 105, upon completion of desired charging or full charging of the vehicle.

12. The system of claim 1, wherein each battery present in the portable charging apparatus 105 and the robot 104 is smart battery, capable of transmitting information to the robot over the network.

13. The system of claim 2, wherein the controller, upon complete charging or desired charging of the vehicle, is configured for:
removing the plug 507 of the portable charging apparatus 105 from the charging port of the vehicle;
placing the plug 507 back to the predefined cavity present over the casing 502 of the portable charging apparatus 105;
connecting the robot 104 to the portable charging apparatus 105 autonomously via the towing mechanism 405, and transporting the portable charging apparatus 105 to the base station 201.

14. The system of claim 1, wherein the one or robotic arms 402 further comprise a tire cap opener device 610, and a tire inflator device 620, configured for:
locating a valve stem of vehicle tyre, and further engage the tire cap opener device 610 precisely over a cap present at the valve stem of the vehicle tire;
unscrewing the cap from the valve stem by actuating the tire cap opener device 610, and removing the tire cap opener device 610 after the cap is completely unscrewed from the tire;
engaging the tire inflator device 620 to the valve stem of the vehicle tire, and inflating the vehicle tire via the tire inflator device 620 for obtaining the desired tire pressure, wherein a stepper motor 621 of the tire inflator device 620 enables control over the tire inflation rate, and ensuring filling of air upto predefined pressure;
disengaging the tire inflator device 620 from the valve stem of the tire upon achieving predefined pressure in the tire;
screwing/turning the cap over the valve stem by using the tire cap opener device wherein the cap is already present within the tire cap opener device 610, and ensuring a secure fit of the cap over the valve stem of the tire.

15. A method 700 of charging an electric vehicle in the parking lot, the method comprising the steps of:
receiving, via the controller, a request for charging the vehicle from a user;
displacing, via the controller, the robot 104 from present location towards one of the portable charging apparatus 105 present at base station 201, wherein the one of the portable charging apparatus 105 is selected by the robot 104 based on either distance between robot 104 and the portable charging apparatus 105, or amount of battery charge available in the portable charging apparatus 105, or distance between the portable charging apparatus 105 and the vehicle's parking location, category of the vehicle, or a combination thereof;
connecting, via the controller, one of the portable charging apparatus 105 to the robot 104 by actuating a towing mechanism 405 of the robot 104, wherein the towing mechanism 405 actuates upon receiving the information from plurality of sensors 403 of the robot 104 and upon reaching of the robot 104 within a predefined range of the portable charging apparatus 105;
transferring, via the controller, the robot 104 and the engaged portable charging apparatus 105 from the base station 201 to the electric vehicle's parking location, by optimizing the route using real-time mapping data and one or more path planning algorithms;
actuating, via the controller, one or more robotic arms 402 for placing the plug 507 from the portable charging apparatus 105 over charging port of the vehicle, upon reaching the vehicle's parking location;
communicating, via the controller, charging information with the system 101 during the charging process at predefined intervals or instances of the vehicle charging;
actuating, via the controller, one or more robotic arms 402 for placing the plug 507 back to the portable charging apparatus 105 from the charging port of the vehicle, upon completing the requested charging;
returning, via the controller, the portable charging apparatus 105 to the base station 201, by connecting the robot 104 and the portable charging apparatus 105 through the towing mechanism 405 of the robot 104.

16. The method of claim 15, further comprising a step of moving the robot 104 either towards other portable charging apparatus 105 or other vehicle present in the parking lot based on the instructions received, by disengaging the engaged portable charging apparatus 105 during charging of the vehicle.

17. A non-transitory computer readable medium storing a program for enabling charging of an electric vehicle in the parking lot, the program comprising:
a program code for receiving, via the controller, a request for charging the vehicle from a user;
a program code for displacing the robot 104 from present location towards one of the portable charging apparatus 105 present at base station 201, wherein the one of the portable charging apparatus 105 is selected by the robot 104 based on one or more parameters, wherein the one or more parameters such as distance between robot 104 and the portable charging apparatus 105, amount of battery charge available in the portable charging apparatus 105, distance between the portable charging apparatus 105 and the vehicle's parking location, category of the vehicle, or a combination thereof;
a program code for connecting the one of the portable charging apparatus 105 to the robot 104 by actuating a towing mechanism 405 of the robot 104, wherein the towing mechanism 405 is actuated based on the receiving the information from plurality of sensors 403 of the robot 104 and upon reaching of the robot 104 within a predefined range of the portable charging apparatus 105; a program code for transferring the robot 104 and the engaged portable charging apparatus 105 to the electric vehicle, by optimizing the route using real-time mapping data and one or more path planning algorithms;
a program code for actuating one or more robotic arms 402 for placing the plug 507 from the portable charging apparatus 105 over charging port of the vehicle, upon reaching the vehicle's parking location;
a program code for communicating charging information with the system 101 during the charging process at predefined intervals or instances of the vehicle charging
a program code for actuating one or more robotic arms 402 for placing the plug 507 back to the portable charging apparatus 105 from the charging port of the vehicle, upon completing the requested charging;
a program code for returning the portable charging apparatus 105 to the base station 201, by connecting the robot 104 and the portable charging apparatus 105 through the towing mechanism 405 of the robot 104.
